(19) United States
(12) Patent Application Publication
(10) Pub. No.: US 2018/0192122 A1
(43) Pub. Date: Jul. 5, 2018

(54) ENHANCED HOME MEDIA EXPERIENCE USING A WIRELESS MEDIA HUB

(71) Applicant: Blackfire Research Corporation, San Francisco, CA (US)

(72) Inventor: Ravi Rajapakse, San Francisco, CA (US)

(21) Appl. No.: 15/436,723

(22) Filed: Feb. 17, 2017

Related U.S. Application Data
(60) Provisional application No. 62/442,969, filed on Jan. 5, 2017.
(60) Provisional application No. 62/449,576, filed on Jan. 23, 2017.

(51) Int. Cl. H04N 21/436; H04L 12/28; H04N 21/422

(52) U.S. Cl. CPC H04N 21/43615; H04L 12/2816; H04L 2012/2841; H04L 2012/2849; H04N 21/42221

(57) ABSTRACT

A system and method for enhanced home media experience using a wireless media hub, comprising a wireless media hub configured to act as a many-to-many hub for a variety of over-the-top media devices and media output devices, wherein a virtual screen is presented to a user for interaction and media source and destination devices are selected and directed based on user interaction via the virtual screen.

### CROSS-REFERENCE TO RELATED APPLICATIONS

This application claims priority to U.S. provisional patent application Ser. No. 62/449,576, titled “ENHANCED HOME MEDIA EXPERIENCE USING A WIRELESS MEDIA HUB”, filed on Jan. 23, 2017 and also claims priority to U.S. provisional patent application Ser. No. 62/442,969, titled “WIRELESS MEDIA HUB” filed on Jan. 5, 2017, the entire specification of each of which is incorporated herein by reference in its entirety.

### BACKGROUND OF THE INVENTION

### Field of the Art

The disclosure relates to the field of computing devices, and more particularly to the field of media computing devices.

### Discussion of the State of the Art

Many different manufacturers offer over-the-top (“OTT”) services for delivering streaming media to home entertainment systems over the Internet (for example, APPLE TV™, ROKU™, NETFLIX™, GOOGLE CHROMECAST™, and so forth). In many cases, proprietary hardware is needed, and each service requires a separate connection to today's smart televisions. Moreover, many hardware and software vendors are actively developing their own branded media content, and these vendors often try to limit playback of their own content to their own or their partners' systems. The emergence of “walled gardens” and the multiplication of proprietary hardware devices and interface protocols has tended to “balkanize” home entertainment systems, and to make their use frustratingly complex for consumers. Moreover, many consumers use wireless extensively today, for example by using sophisticated wireless speaker systems; it is crucial and increasingly difficult to deliver high-quality, tightly synchronized audio and video in these conditions, while minimizing latency—this is usually difficult to accomplish in wireless environments in any case, but becomes much more so when multiple vendors using various protocols and technologies all try to make use of the same wireless infrastructure in home environments.

What is needed, then, is a smart wireless media hub that overcomes these and other obstacles in the home entertainment art.

### SUMMARY OF THE INVENTION

Accordingly, the inventor has conceived and reduced to practice, in preferred embodiments of the invention, a system and method for providing an enhanced home media experience using a wireless media hub. The following non-limiting summary of the invention is provided for clarity, and should be construed consistently with embodiments described in the detailed description below.

To address the problems noted above, the inventor conceived of a wireless media hub (“WMH”) that may operate in a variety of physical form factors. The WMH may be a standalone electronic device that allows third-party OTT devices and video dongles to be connected directly, and that connects to various media rendering devices wirelessly. It may also be a “WMH-on-a-stick”; that is, it may be physically configured as an HDMI (or other interface) stick (with a male HDMI or other interface adapter on one end), with one or more input ports for receiving third-party OTT devices and video dongles, while again communicating with various playback devices via wireless (and delivering high-definition video to a display device via the HDMI or other interface). In another embodiment, the WMH may be built into a smart television or other advanced media playback device, and receive connections from third-party OTT devices directly (via HDMI or other physical interfaces) or wirelessly.

According to a preferred embodiment of the invention, a system for providing an enhanced home media experience using a wireless media hub, comprising: a wireless media hub comprising: a plurality of hardware connectivity ports each configured to receive media content from a connected device; a plurality of wireless network interfaces; a software operating system; a virtual screen manager configured to transmit at least a virtual screen via at least a wireless network interface; a protocol manager configured to identify a device connected via at least one of the plurality of hardware connectivity ports, and configured to direct the operation of at least a media processing operation based on identified device characteristics; and a plurality of infrared communication ports, is disclosed.

According to another preferred embodiment of the invention, a method for providing an enhanced home media experience, comprising the steps of: connecting, via a plurality of hardware connectivity ports each configured to receive media content from a connected device, to a third-party media device; identifying, using a protocol manager configured to identify a device connected via at least one of the plurality of hardware connectivity ports, and configured to direct the operation of at least a media processing operation based on identified device characteristics, device characteristics of the third-party media device; transmitting, using a virtual screen manager configured to transmit at least a virtual screen via at least a wireless network interface, a virtual screen comprising at least a selection indicia representing the third-party media device; receiving user interaction via the virtual screen; directing, using a plurality of infrared communication ports, the operation of the third-party media device based at least in part on the user interaction; receiving media from the third-party media device; processing at least a portion of the media based at least in part on the identified device characteristics; and transmitting at least a portion of the media for rendering at a destination device, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for a wireless media hub, and its interactions with various devices commonly used in home entertainment systems, according to a preferred embodiment of the invention.

FIG. 2 illustrates a system architecture for a wireless media hub, according to a preferred embodiment of the invention.

FIG. 3 shows an arrangement where the wireless media hub is provided as a media-hub-on-a-stick, according to an embodiment of the invention.

FIG. 4 shows an arrangement where the wireless media hub is implemented as an internal component of a smart television, according to an embodiment of the invention.

FIG. 5 is a method diagram illustrating a method of providing an enhanced home media experience, according to a preferred embodiment of the invention.

FIG. 6 is a block diagram illustrating an exemplary hardware architecture of a computing device used in an embodiment of the invention.

FIG. 7 is a block diagram illustrating an exemplary logical architecture for a client device, according to an embodiment of the invention.

FIG. 8 is a block diagram showing an exemplary architectural arrangement of clients, servers, and external services, according to an embodiment of the invention.

FIG. 9 is another block diagram illustrating an exemplary hardware architecture of a computing device used in various embodiments of the invention.

FIG. 10 is a method diagram illustrating a method for providing an enhanced home media experience using wireless radio communication, according to an embodiment of the invention.

FIG. 11 is a method diagram illustrating a method for providing an enhanced home media experience by facilitating interaction between multiple third-party ecosystems, according to an embodiment of the invention.

FIG. 12 is a method diagram illustrating a method for providing an enhanced home media experience by streaming media to multiple destinations, according to an embodiment of the invention.

### DETAILED DESCRIPTION

The inventor has conceived, and reduced to practice, in preferred embodiments of the invention, a system and method for providing an enhanced home media experience using a wireless media hub.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

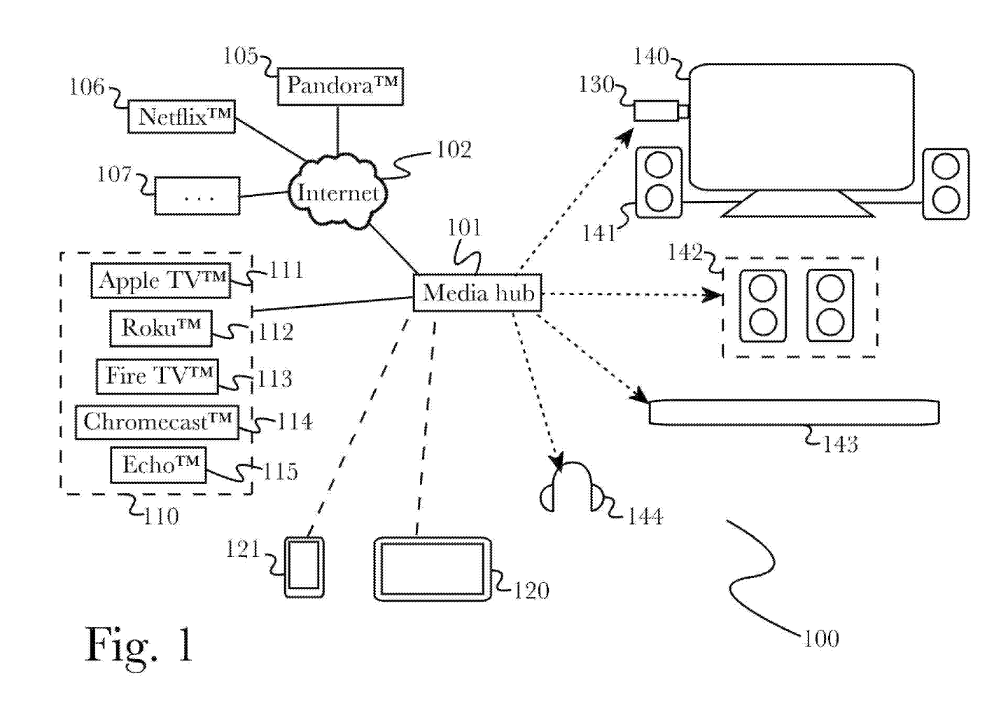

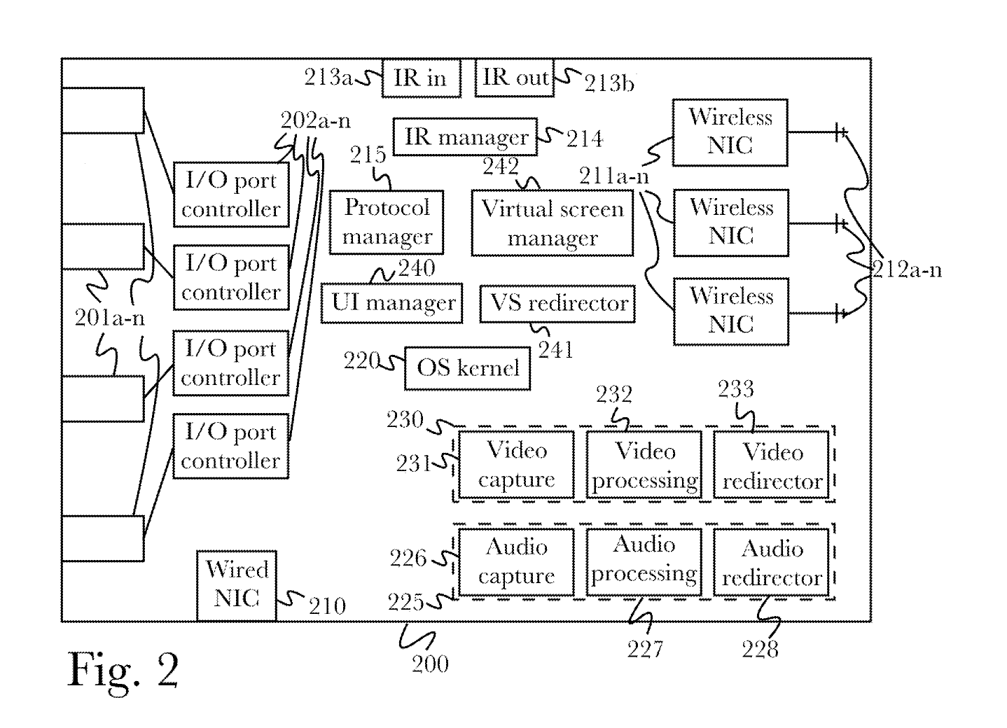

FIG. 1 is a block diagram illustrating an exemplary system architecture 100 for a wireless media hub 101, and its interactions with various devices commonly used in home entertainment systems, according to a preferred embodiment of the invention. According to the embodiment, media hub 101 may receive raw media inputs from a variety of input sources, for example including Internet-based media streaming services such as PANDORA™ 105, NETFLIX™ 106, and other similar services 107 via the Internet 102. Media hub 101 may also receive raw media from a plurality of OTT devices 110 such as including, but not limited to, APPLE TV™ 111, ROKU™ 112, AMAZON FIRE TV™ 113, GOOGLE CHROMECAST™ 114, and other AMAZON™ devices such as ECHO™ 115, or any of a variety of additional or alternate devices that are available or may be introduced. Some of these devices 110 may communicate with media hub 101 wirelessly such as using a WiFi local area network (LAN), and some may be directly connected via one or more physical ports on wireless media hub 101 (see for example FIG. 2, described below). Media hub 101 may be controlled by one or more mobile devices such as tablets 120 or smartphones 121, or other mobile computing devices according to a particular arrangement or use case. Wireless media hub 101 may also wirelessly send virtual screens to mobile devices to provide a full operating system screen interface to users of mobile devices 120, 121 for interaction, for example providing an interactive user interface operated by the operating system of media hub 101 and instantiated on a per-user basis and transmitted to each user's mobile device 120, 121, rather than requiring users to install and configure an app on their devices for interaction. This arrangement places the technical requirements for operation and interaction (such as hardware resources like memory and processing power) on the media hub, enabling similar interaction regardless of a user's particular mobile device capabilities. Wireless media hub 101 may send high-definition video wirelessly to a video dongle 130 which may in turn be inserted into an HDMI or other port (for example, DISPLAYPORT™ or USB™ ports) of display device 140 (which may be a conventional television, a smart television, a computer display monitor, or another media display device). Wireless media hub 101 may also stream audio wirelessly to one or more audio playback devices synchronously, such as (but not limited to) headphones 144, wireless speakers 141, 142, wireless sound bar 143, and so forth. In some arrangements, wireless media hub 101 may send audio and video to a connected multimedia dongle 130, which may then play video via a connected display device 140 and audio via connected audio devices such as speakers 141 connected to the display device 140 (for example, in a home theater setup with multiple speakers connected to a television).

Examples of how the invention may be used are many. For example, a user may select a movie from a cloud-based service such as NETFLIX™ or AMAZON PRIME™ and direct the video via an HDMI output or a wireless video dongle to a television, while sending the audio wirelessly to a set of speakers to provide a rich audio experience. The user may select how audio is distributed, may select what is to be viewed, and may control viewing settings, all from within a standard OS user interface (including possibly an application retrieved from an app store). In another example, several users may each interact with a game operating on the device. Each user (player) may see the same game screen on their mobile device, or each may see a separate screen. Each player has full interactive functionality within the game on his mobile device. The same, or indeed a different, screen may be shown on the HDMI output device to which the media computing device is connected. For example, a shared screen may be seen on a television, while each player has a private screen for controlling what their character does, with the actions taken by each player on his mobile device simultaneously affecting what is seen on the television.

The delivery of virtual screens to mobile devices from the media computing device may be done by intercepting screen graphics bitmaps (which would normally be sent to a hardware display device for rendering), and transcoding the graphics data into H.264 (for example). The H.264 stream can then be sent in packetized form over a wireless network to each of the mobile devices. Similarly, user interaction events received on the mobile devices (for example, touchscreen interactions) are sent in packetized form over the wireless network to the media computing device, where they are provided to and interpreted by the operating system as if they were user interaction events arriving from an attached touchscreen. In some use modes, each user sees the same OS screen on his mobile device. In one of these modes, each user can simultaneously interact with the OS via his mobile device and the OS uses an interrupt management system (common in operating systems) to ensure that each user's interactions are handled in a timely manner. In another use mode involving a shared virtual screen, only one user at a time has control of the user interface; users could take turns controlling, or users could “seize control” with or without the concurrence of other users (quasi-competitive control of the shared user interface could be part of a game concept). In another use mode, each user is provided with his own virtual screen. For example, many operating systems provide for multiple virtual desktops, so that a user may use different applications on different desktops. In the use mode envisioned, each user interacts with the operating system using his own logical/virtual desktop, which is provided wirelessly as before.

In some cases, a “safe mode” of interaction is provided to enable continued use of the media computing device when network congestion or degradation occurs. For example, in safe mode users would receive simple, text-based notifications from the media computing device wirelessly, which are presented within an application on his mobile device. The user is provided with a set of control selections more akin in functional richness to those provided by remote controls known in the art, thus allowing users to interact with the media computing device in a way analogous to how users interact with a ROKU™ device today.

FIG. 2 illustrates a system architecture for a wireless media hub 200, according to a preferred embodiment of the invention. According to the embodiment, media hub 200 may operate a plurality of physical multimedia input ports 201a-n, each coupled to a media controller 202a-n, for example various arrangements of HDMI, DISPLAYPORT™, USB™, composite or component video, TRS or TRRS (which may come in a variety of physical sizes including but not limited to 2.5 mm, 3.5 mm, and ¼-inch), or other input port types. Media hub 200 may also comprise a plurality of physical network ports such as an Ethernet adapter 210 for connecting to a wired network or to devices that only have wired networking capabilities (for example, a set-top box that does not have a wireless radio), as well as a plurality of wireless network interface controllers (NICs) 211a-n operating a plurality of wireless antennas 212a-n for wireless communication with various networks and devices (for example, different controllers or antennas may be used to communicate using different frequencies or protocols, such as WiFi and BLUETOOTH™), and various combinations of wired and wireless network connections may be used interchangeably and simultaneously according to a particular configuration or use case. Media hub 200 may further comprise a plurality of infrared (IR) input 213a and output 213b ports, that may be used to facilitate interaction with a variety of IR-based remote controls and devices according to various arrangements. For example, media hub 200 may be used to direct the operation of a television that has only IR remote control capabilities, and may be used to receive commands from a remote control via IR input 213a and transmit those commands via IR output 213b to provide a pass-through control scheme for IR devices. Another exemplary use may be to receive commands from a mobile device (as described above, referring to FIG. 1) and convert those commands using an IR manager 214 to be retransmitted via IR output 213b to enable control of IR-based devices without the use of an IR-based remote.

Wireless media hub 200 may further comprise a software operating system 220, such as ANDROID™, IOS™, LINUX™, or WINDOWS™, and depending on the particular configuration or use case does not necessarily have any built-in user interface, but rather uses a virtual screen driver 242 to provide full operating system user interface screens to users of mobile devices. One or more virtual screens may be managed by a UI manager 240 and may be transmitted to and interacted with simultaneously by mobile device users, and each user may receive a virtualized OS instance that is kept separate from other connected users, so each user may interact freely without conflict. A mobile device user may be presented with a typical operating system home screen or desktop environment (depending on the operating system used), and can interact with the screen using the native touchscreen or other hardware capabilities of their mobile device to perform any actions normally available in the operating system (for example, a touchscreen may be used for direct interaction while physical buttons may be used to control volume or play/pause functionality). The home screen, virtual screen, or virtual desktop may be presented within an application on the mobile device, thus providing a “full OS inside an app” modality to the user, with actions taken by the user affecting what appears on a media display device and what is played back on various audio playback devices. Additionally, a virtual screen redirector 241 may be used to optionally present a particular user's OS instance (or other virtual screen) to a display output device, for example if a user wishes to broadcast their screen on a television or monitor for other users to see (as may be useful for instructional purposes such as giving a demonstration to others or asking for feedback).

Wireless media hub 200 may operate a plurality of audio 225 and video 230 processing components, that may be used to receive, process, and transmit various media during use. Audio 226 and video 231 capture components may be used to receive media from connected devices (either via physical 201a-n or wireless 212a-n connectivity means), and provide content to audio 227 and video 232 processors for any necessary modification such as transcoding video or splitting audio streams for individual handling. Media may then be provided to audio 228 and video 233 redirector components (either after processing or in an as-received, unaltered state) for retransmission to output devices, such as to transmit individual audio channels to separate physical speakers or to transmit video to a display device. A protocol manager 215 may be utilized to direct media handling according to a variety of media protocols, such as to direct on-the-fly transcoding of audio or video into different bitrates, resolutions, encoding schema, container formats, or other such protocol-based processing. Using various combinations of physical and wireless connections and audio/video processing capabilities, wireless media hub 200 may receive media from one type of third-party OTT device (such as APPLE TV™) and stream it to another type of third-party OTT device (such as GOOGLE CHROMECAST™) wirelessly, performing necessary protocol conversions internally without disrupting the streaming operation. Moreover, wireless media hub 200 is capable of acting as a conventional infrared remote for a wide variety of devices using IR input 213a and output 213b ports as described above, and of receiving remote control signals from those devices. It is also an aspect of the invention that audio captured from a media streaming source (i.e., a third-party OTT device, a video or audio dongle, or a direct Internet connection to an Internet music service such as PANDORA™) may be processed before being redirected to one or more audio playback devices wirelessly. Such reprocessing may include diverting 2.0 audio channels to one device (such as a personal mobile device only capable of playing 2.0 audio directly), while streaming 3.1 audio to wireless speakers, providing a full 5.1 audio experience (or better, for example 7.1) using a variety of playback devices, some of which may not themselves be equipped to participate in 5.1 or better audio rendering. In some cases, stereo audio may be captured and converted into 5.1 within the wireless media hub before being redirected to one or more audio playback devices.

Utilizing the capabilities described above, wireless media hub 200 can act as a many-to-many hub for media distribution, and can manage media from multiple sources, destined for multiple destinations (including destinations physically remote from wireless media hub 200, for example for streaming media to a remote user's device), performing necessary protocol conversions as needed. Moreover, the wireless media hub can automatically detect the type of a media source when it is connected; for example, if a GOOGLE CHROMECAST™ dongle is attached to the wireless media hub, the wireless media hub will autodetect that it is a CHROMECAST™ device and interact with it accordingly. When presenting virtual screens to users, a user may be able to select input and output devices for media rendering from lists of available connected devices. For example, a user can select a source device such as a streaming media service or a connected media device such as a ROKU™, optionally selecting specific content such as a playlist or channel (for example, a specific channel on a ROKU™ or APPLE TV™ device), and may then select a plurality of output devices such as speakers for audio and a display for video. This may be used to bridge gaps between content providers and devices, enabling a user to play content (including proprietary content) on devices of their choosing. This also enables the use of a user's mobile device as a single, unified remote control device for multiple media devices and services, rather than requiring a user to use (and keep track of) different proprietary remotes for each device they want to connect and use.

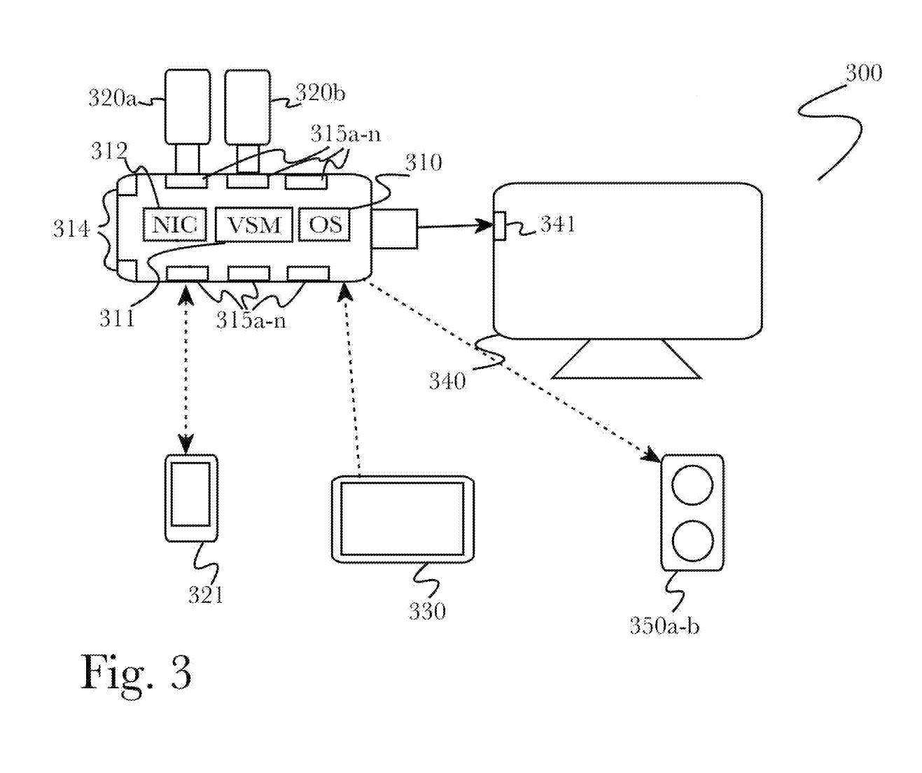

FIG. 3 shows an arrangement 300 where the wireless media hub 301 is provided as a media-hub-on-a-stick, according to an embodiment of the invention. According to the embodiment, wireless media hub 301 may be configured in a physical arrangement similar to a streaming multimedia dongle such as a CHROMECAST™ or ROKU STREAMING STICK™, that may be physical connected to a display device 340 (such as a television or computer display monitor) via a physical port 341 such as HDMI, DISPLAYPORT™, USB™, or other hardware connectivity port, and may use this physical connection to provide media to display device 340 while also optionally drawing power from display device 340 via the hardware connection 341 (for example, using MHL™). In this arrangement, wireless media hub 301 may still comprise components described previously (referring to FIG. 2), including an operating system 310, virtual screen manager 311, and a plurality of wireless NICs 312. A variety of physical connectivity ports 315a-b, 316a-b may be positioned about the device's exterior for connecting a variety of third-party devices 320a-b (such as CHROMECAST™ or ROKU™ media sticks, USB™ storage devices, or other such devices that may be connected via a hardware port), and a plurality of IR input and output ports may be positioned for maximum visibility 314 to provide IR interaction capabilities.

According to the embodiment, users may interact with the wireless media hub 301 using their mobile devices, such as a tablet 330 or smartphone 321, communicating with hub 301 wirelessly while it remains connected to the display device 340. Wireless media hub 301 may also communicate wirelessly with a plurality of additional media output devices, such as satellite speakers 350a-b that may be used to render audio transmitted wirelessly from media hub 301 while other content is transmitted to display device 301 via the hardware connection 341. For example, video may be shown on display device 340 while corresponding audio is transmitted to speakers 350a-b for rendering, or unrelated audio may be transmitted to speakers 350a-b such as for passive use wherein a screensaver or photo slideshow (or other content) may be presented on display device 340 while background or ambient music may be played via speakers 350a-b, or various other combinations. Additionally, media may be transmitted to a user's device 330, 321 in addition to or in place of a virtual screen, such as for a user to view video or listen to music on their personal device while other media (or nothing at all) is transmitted to display device 340 and speakers 350a-b. In this manner, individual users may view and listen to their own content without affecting others, and various combinations of individual (on a user's mobile device) and room-based (such as on a television and speakers) media rendering are possible.

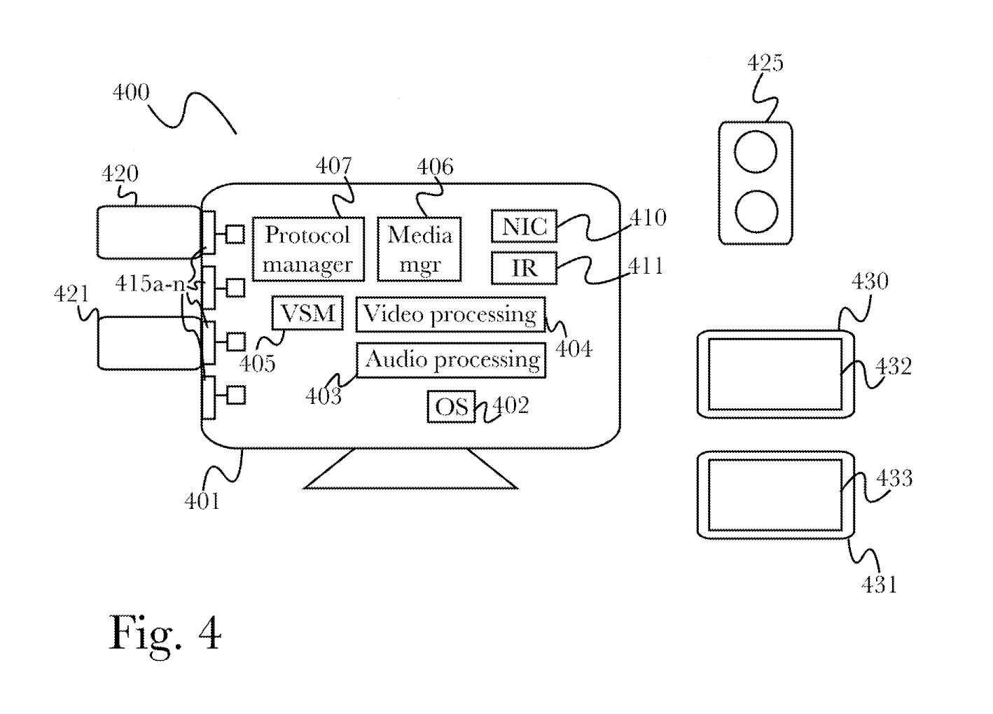

FIG. 4 shows an arrangement 400 where the wireless media hub 401 is implemented as an internal component of a smart television 401, according to an embodiment of the invention. According to the embodiment, a wireless media hub may be integrated within a smart television 401 in a manner similar to devices such as ROKU TV™, wherein the components and capabilities of the media hub are provided as native features of the television 401 without any additional setup or configuration. According to the embodiment, the smart television 401 may operate a plurality of physical connections 415a-n for connecting third-party devices such as (for example) an OTT device 420 or a streaming media dongle 421, and these devices may then be used as source devices in a many-to-many configuration as described previously (referring to FIG. 2). Smart TV 401 may operate an internal operating system 402 and may use a virtual screen manager 405 to instantiate and present virtual screens to user devices 430, 431 so users may interact using their device touchscreens 432, 433, for example to select source and destination devices for use during media rendering. A media manager 406 may be used to index and organize content for presentation to users, such as to group devices, channels and playlists for easy navigation and selection when making source and destination selections. Protocol manager 407 may be used to direct the operation of a variety of audio 403 and video 404 processing operations such as for file conversion or transcoding, and a plurality of wireless NICs 410 and IR input and output ports 411 may be used for communicating wirelessly with various devices such as additional third-party OTT devices (for example, APPLE TV™ or ROKU™) or external media rendering hardware such as satellite speakers 425 that may be used for media playback.

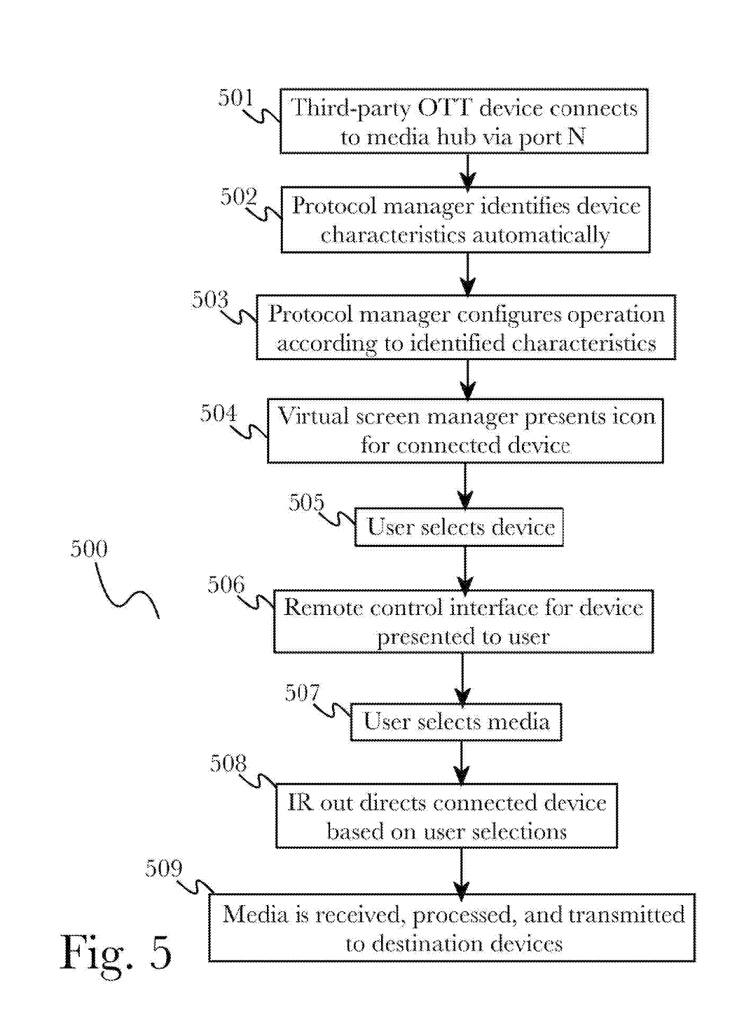

FIG. 5 is a method diagram illustrating a method 500 of providing an enhanced home media experience, according to a preferred embodiment of the invention. In an initial step 501, a third-party OTT device (such as including, but not limited to, APPLE TV™, ROKU™, or AMAZON FIRE TV™) may connect to a wireless media hub 200 via a hardware connectivity port “N”, that may be any appropriate hardware port such as including (but not limited to) HDMI, DISPLAYPORT™, USB™, or other hardware connectivity port. In a next step 502, wireless media hub 200 may automatically identify the connected device, for example identifying hardware and software capabilities and vendor or model information. In a next step 503, this device information may be used by a protocol manager 215 to automatically configure protocol information for port N, to appropriately handle received content from the connected device. In a next step 504, a virtual screen manager 242 may create a new icon or label representing the connected device, that may be shown on virtual screens that may be presented to users for selection. In a next step 505, a user may interact with a virtual screen presented on their device, and may select the connected device either by explicitly selecting the device's representative icon or label, or by selecting the port to which the device is connected (for example, if a user knows they want to use “HDMI input 2” as a media source, without knowing the details of the device connected to that port). In a next step 506, virtual screen manager 242 may present a remote control interface or app to the user, corresponding to the selected media device (for example, a ROKU™ remote control interface if a user selects a ROKU™ device). In a next step 507, the user may select media for streaming using the presented virtual remote control screen, such as selecting a specific file or playlist, or selecting a streaming source such as a channel or streaming service from which the selected OTT device can receive media for playback. In a next step 508, wireless media hub 200 may use an IR port 213b to transmit appropriate signals to the OTT device as needed, converting a user's interaction into corresponding IR commands using an IR manager 214. In a final step 509, the selected media is then received from the OTT device via the connected port N, processed as needed using audio 225 and video 230 processing (for example, to convert formats or transcode media content), and streamed to a plurality of connected playback devices.

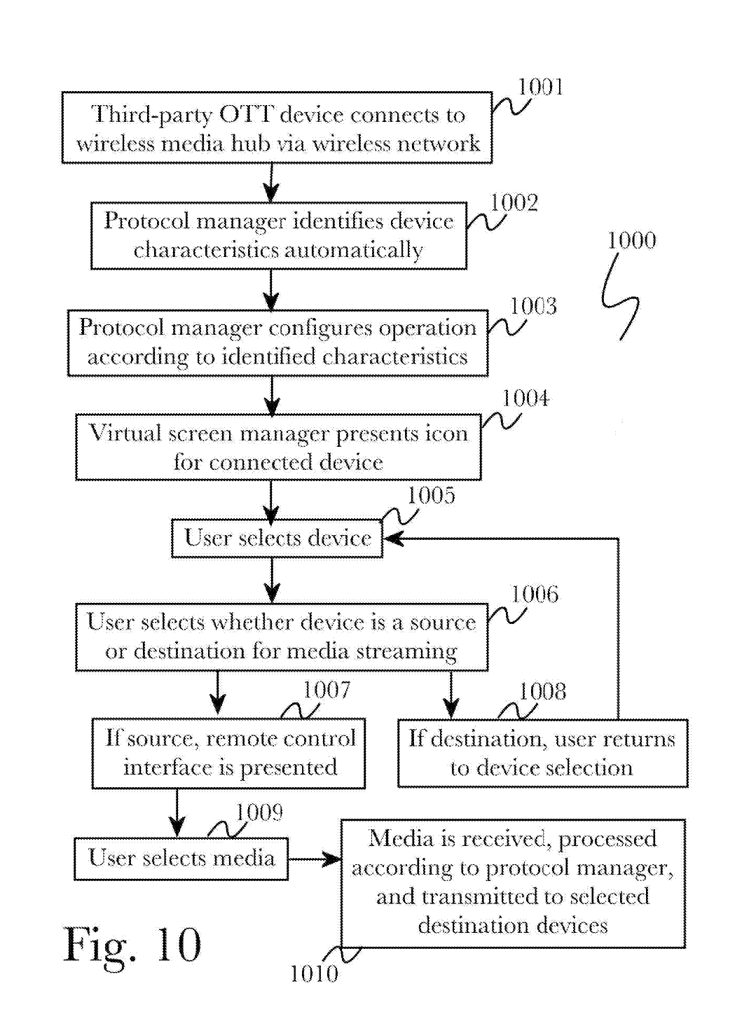

FIG. 10 is a method diagram illustrating a method 1000 for providing an enhanced home media experience using wireless radio communication, according to an embodiment of the invention. In an initial step 1001, a third-party OTT device (such as including, but not limited to, APPLE TV™, ROKU™, or AMAZON FIRE TV™) may connect to a wireless media hub 200 via a wireless network connection such as Wi-Fi (or optionally using direct wireless communication, such as BLUETOOTH™). Each device that connects in this manner may optionally use a different wireless configuration, for example communicating via different protocols or frequencies. Multiple devices may connect in this manner using multiple wireless network interfaces 212a-n of media hub 200, enabling simultaneous communication with devices of varying capabilities and configurations. In a next step 1002, wireless media hub 200 may automatically identify the connected device, for example identifying hardware and software capabilities and vendor or model information. In a next step 1003, this device information may be used by a protocol manager 215 to automatically configure protocol information for the connected device, to appropriately handle received content from the connected device. In a next step 1004, a virtual screen manager 242 may create a new icon or label representing the connected device, that may be shown on virtual screens that may be presented to users for selection. In a next step 1005, a user may interact with a virtual screen presented on their device, and may select the connected device by selecting the presented representative icon, and in a next step 1006 the user may select whether the device is to be used as a media source, or as a media streaming destination. If the user selects the device as a media streaming destination 1008, they may then return to a device selection screen to select additional devices to be used as streaming destinations or to select a media source device (this allows a user to select multiple destinations for a single streaming source, for example to stream video to one device and audio to several others such as wireless speakers, or to broadcast a single audio/video stream to multiple devices for multi-user viewing, or other arrangements). If the device is determined to be a media source, virtual screen manager 242 may present a remote control interface or app to the user in a next step 1007, corresponding to the selected media device (for example, a ROKU™ remote control interface if a user selects a ROKU™ device). In a next step 1009, the user may select media for streaming using the presented virtual remote control screen, such as selecting a specific file or playlist, or selecting a streaming source such as a channel or streaming service from which the selected OTT device can receive media for playback. In a final step 1010, wireless media hub 200 may direct the source device via the wireless network (and based on any relevant device information identified by the protocol manager 215, such as messaging protocols or wireless hardware capabilities of the connected device), the selected media is then received from the OTT device via the network, processed as needed using audio 225 and video 230 processing (for example, to convert formats or transcode media content), and streamed to selected destination devices.

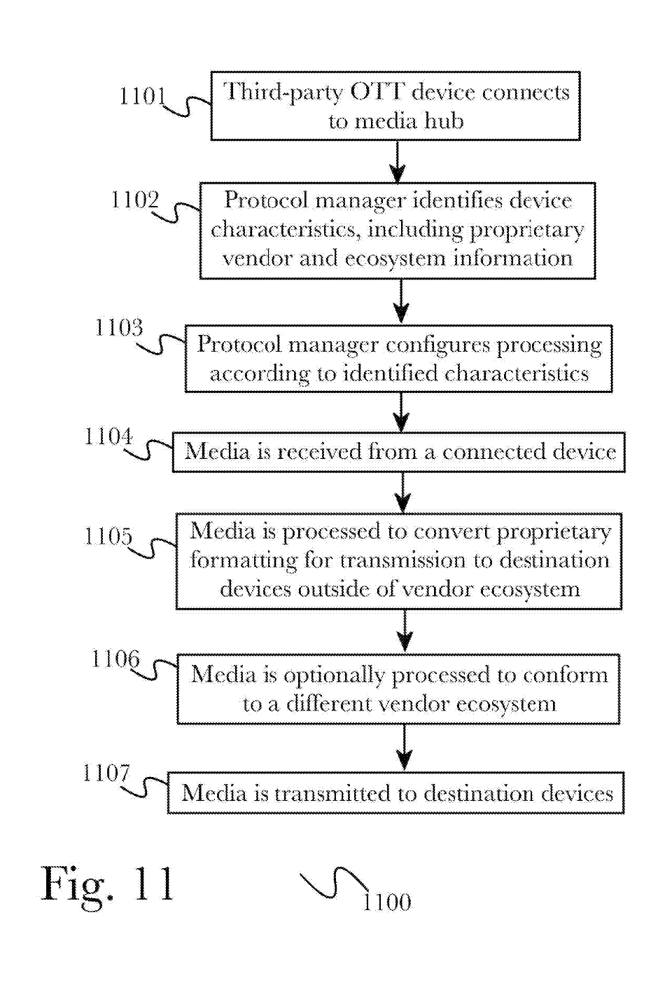

FIG. 11 is a method diagram illustrating a method 1100 for providing an enhanced home media experience by facilitating interaction between multiple third-party ecosystems, according to an embodiment of the invention. According to the embodiment, in an initial step 1101 a third-party device connects to wireless media hub 200 using any available connectivity means (for example, hardware connectivity ports such as HDMI or DISPLAYPORT™, or a wireless network, or direct wireless communication such as infrared or BLUETOOTH™). In a next step 1102, protocol manager 215 may identify a connected device's characteristics, including vendor information and the device's software ecosystem (for example, any proprietary file or communication formats that may be utilized, or device-specific media types or sources such as Internet streaming sources available as channels on the device). In a next step 1103, protocol manager 215 may configure processing operations based on identified device ecosystem and other characteristics, for example so that media may be processed to convert or encapsulate proprietary information into “device agnostic” or universal types for compatibility with devices from other vendors or that do not conform to a particular ecosystem. In a next step 1104, media is received and then in a next step 1105 it may be processed to convert any proprietary formatting (such as media protocols or file container formats) into a form that is compatible with a destination device or that is not device-specific for broad compatibility. In a next step 1106, media may optionally be processed to conform to a particular destination ecosystem, for example for transmission to a device that has specific configuration parameters or rules for receiving media, or to take advantage of features offered by a particular ecosystem on a destination device (such as specific audio formats such as lossless compression, or specific software interface features that may depend on or interact with specific media characteristics, such as looking up information on actors present in a scene using embedded metadata, or other such uses), and then in a final step 1107 media is transmitted to destination devices in formats appropriate for their configuration. Additionally, some processing operations for bridging media between device ecosystems may rely on emulating a media source or destination device to the third-party OTT device, for example wireless hub 200 may identify itself as a television to a device that is configured only to provide direct media output to a destination, such as a media streaming stick or APPLE TV™. In this manner, devices from different vendors may be used in conjunction with each other regardless of software or hardware limitations, for example media may be selected for streaming from an APPLE TV™ device and processed for transmission to a CHROMECAST™ device as a destination, when ordinarily these devices are not designed to interact with each other and are configured to interact directly with a television or other destination or output device directly. In this manner, wireless media hub 200 may be utilized in a many-to-many configuration, serving as a central hub for a wide variety of device and ecosystem types for broad compatibility and interaction.

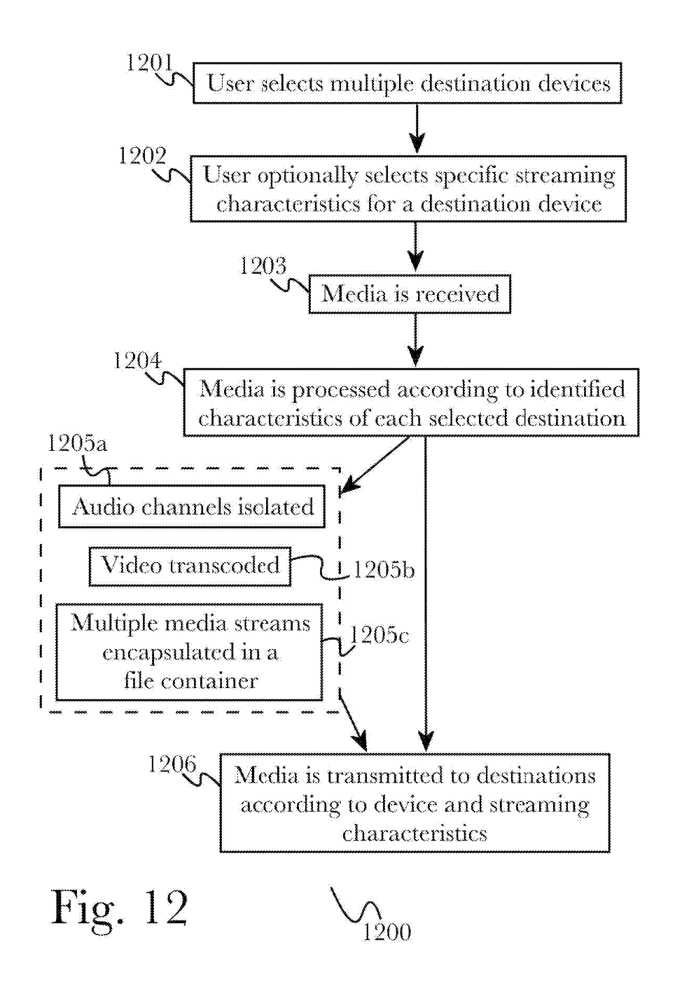

FIG. 12 is a method diagram illustrating a method 1200 for providing an enhanced home media experience by streaming media to multiple destinations, according to an embodiment of the invention. According to the embodiment, in an initial step 1201 a user may select multiple media destination devices for streaming (as described above, with reference to FIG. 10). In a next step 1202, the user may optionally select and configure specific streaming characteristics for some or all destination devices, such as selecting audio or video channels to be transmitted to a particular device, or to select formatting characteristics such as media or container types, resolution or bitrate, color depth, or other such media characteristics. In a next step 1203, media is received and then may be processed 1204 according to the destination device characteristics. Processing steps may include (but are not limited to) separating audio channels 1205a for individual streaming to separate devices (for example, for multichannel surround audio using multiple speakers placed around a room), transcoding video 1205b to conform to a destination device's configuration (such as re-encoding for a different resolution, color depth, bitrate, or encoding scheme), or encapsulating multiple media streams within a file container 1205c, for example to stream multiple audio channels or multiple video tracks to a destination device (for example, some devices may allow a user to select from different video tracks to select different resolutions or to use subtitles embedded within the video, or to select different audio tracks such as ones with cast/crew commentary or in different languages). In a final step 1206, media is transmitted to destination devices according to their characteristics and the selected streaming configuration.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

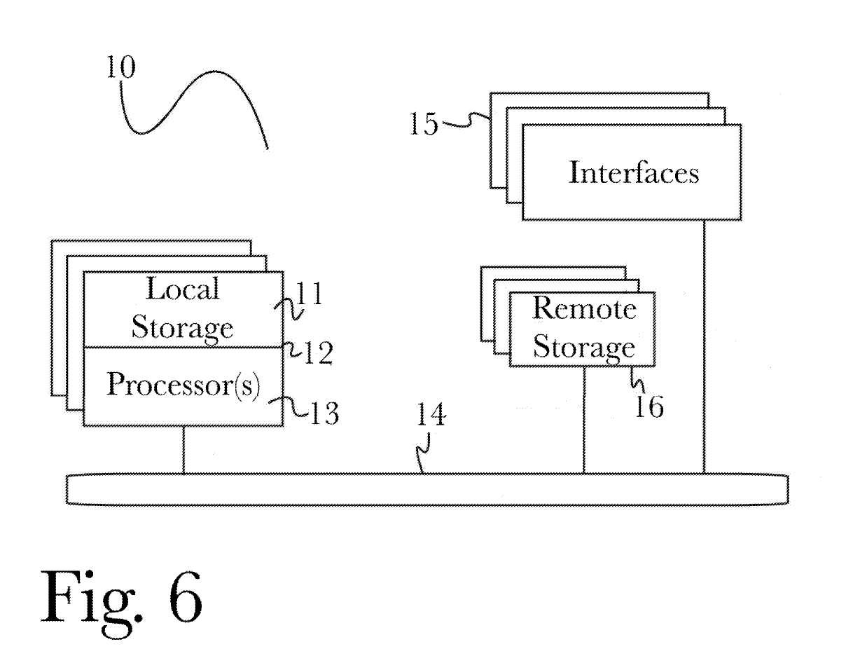

Referring now to FIG. 6, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 6 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

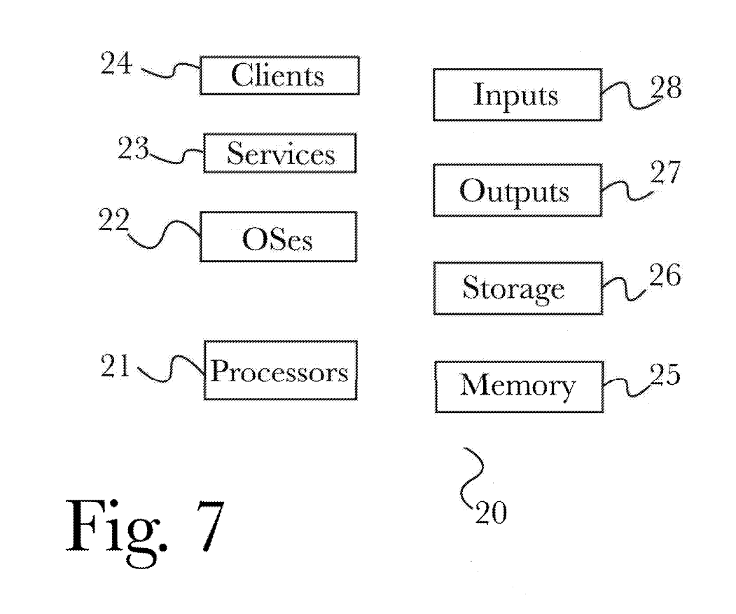

In some embodiments, systems according to the present invention may be implemented on a standalone computing system. Referring now to FIG. 7, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™, MACOS™, or IOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 6). Examples of storage devices 26 include flash memory, magnetic hard drive, CD-ROM, and/or the like.

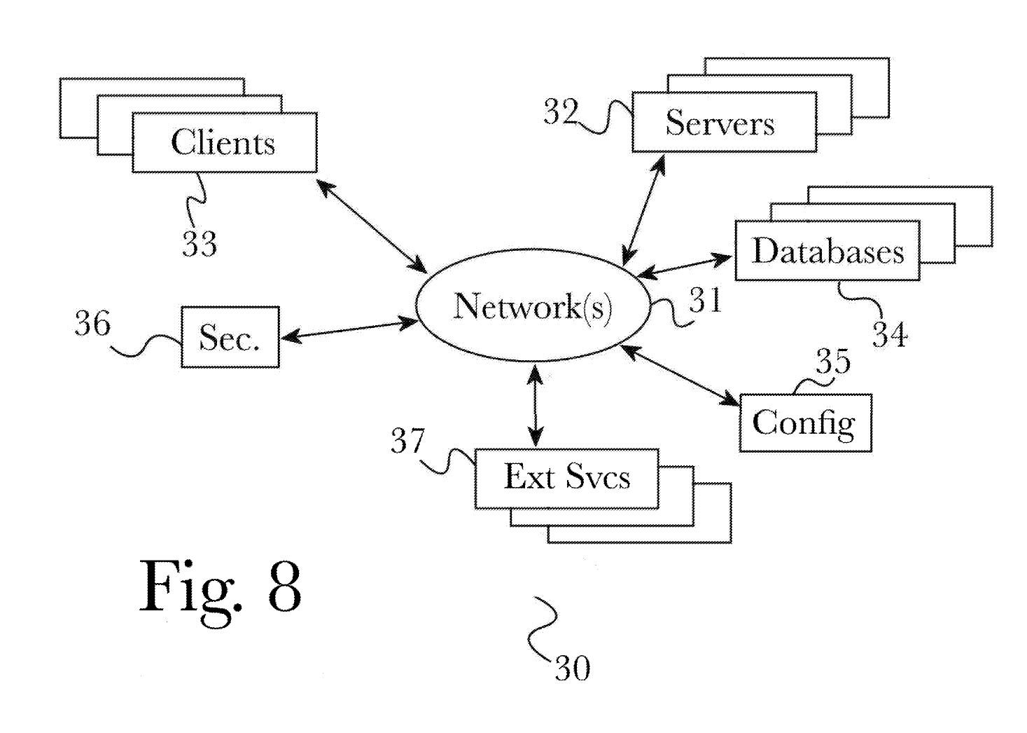

In some embodiments, systems of the present invention may be implemented on a distributed computing network, such as one having any number of clients and/or servers. Referring now to FIG. 8, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 7. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

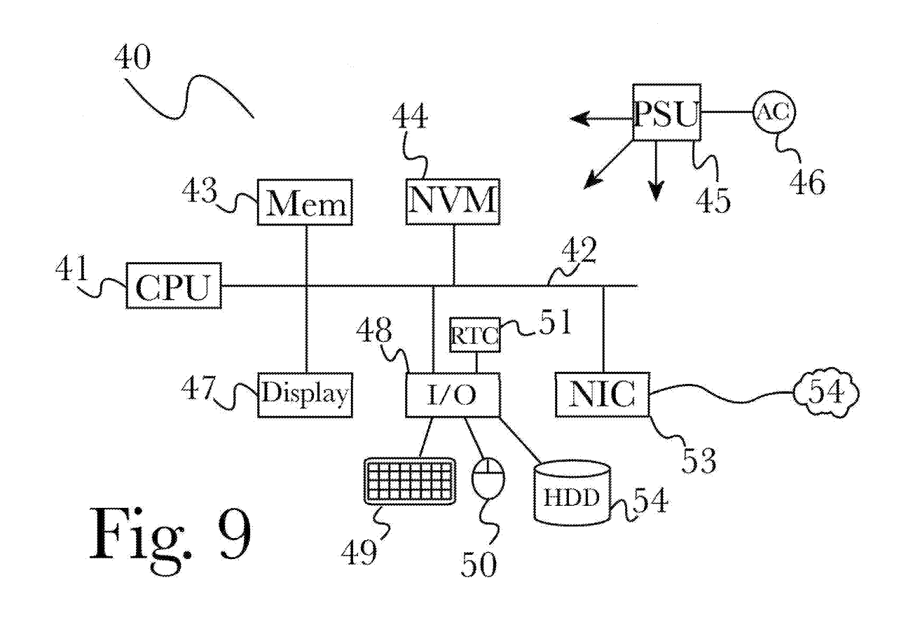

FIG. 9 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

1. A wireless media hub comprising:
a processor;
a memory;
a plurality of hardware input ports each configured to receive media content from a device;
a wireless network interface; and
an operating system comprising programming instructions stored in the memory and operating on the processor and configured to:
operate a protocol manager configured to identify a plurality of device characteristics of a device connected via one of the plurality of hardware ports, and configured to direct the operation of at least a portion of the plurality of media processing components based on at least a portion of the identified device characteristics;
send screen graphics via a virtual screen driver to a plurality of mobile devices;
receive user interaction events from a mobile device via the wireless network interface;
receive media content from a hardware port;
separate the media content into an audio stream and a video stream;
send the audio stream to a plurality of audio playback devices via the wireless network interface;
send the video stream to a display device using the wireless network interface; and
synchronize the playback of the audio stream and the video stream using a synchronization manager.

2. A method for providing an enhanced home media experience using a wireless media hub, comprising the steps of:
connecting, via a plurality of hardware ports each configured to receive media content from a device, to a media device;
identifying, using a protocol manager configured to identify a plurality of device characteristics of a device connected via one of the plurality of hardware ports, and configured to direct the operation of at least a portion of the plurality of media processing components based on at least a portion of the identified device characteristics, device characteristics of the media device;
placing, on a home screen, at least a selection indicia representing the media device;
creating, using a virtual screen manager configured to operate a virtual screen comprising at least the home screen, and configured to transmit the virtual screen via a wireless network interface, a virtual screen comprising at least the home screen;
transmitting, via a wireless network interface, at least the virtual screen to a user device;
receiving user interaction via the virtual screen;
directing the operation of the media device based at least in part on the user interaction;
receiving media from the media device;
processing, using a plurality of media processing components, each media processing component configured to modify at least a portion of the media content, at least a portion of the media based at least in part on the identified device characteristics; and
transmitting at least a portion of the media for rendering at a destination device.
